(19) United States
(12) Patent Application Publication
(10) Pub. No.: US 2006/0006125 A1
(43) Pub. Date: Jan. 12, 2006

(54) Oil from water separation system

(76) Inventors: David Bleasdale Tolmie, East Ryde (AU); Phineas Balantyne Stone, Harbord (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/997,004

(22) Filed: Nov. 23, 2004

Related U.S. Application Data
(63) Continuation-in-part of application No. 09/403,800, filed on Feb. 22, 2000, now Pat. No. 6,824,696.

(30) Foreign Application Priority Data
May 23, 2002 (AU) PS 2531

(51) Int. Cl. B01D 17/025

(52) U.S. Cl. 210/801; 210/521; 210/538

(57) ABSTRACT

The present invention relates to the separation of non-miscible pollutants, such as oil from water. It discloses a separator system which incorporates a separator structure having a oil disengagement chamber where an oil/water mix may separate and an effluent water chamber. In addition the system also comprises as a first stage a volume of an existing reticulation system, such as storm water drainage. A separator structure constructed from standard piping is also disclosed.

### RELATED APPLICATIONS

This application is a national phase application of PCT Application No. PCT/AU03/00627 which claims the benefit of Australian App No. PS2531, filed May 23, 2002; and a continuation-in-part of U.S. patent application No. 09/403,800 filed Feb. 22, 2000 and titled “OIL FROM WATER SEPARATOR,” which entered national phase from PCT Application No. PCT/AU98/00298 filed Apr. 24, 1998. This application thereby claims priority to the filing date of PCT Application No. PCT/AU03/00627 and Australian Application No. PS 2531 filed May 23, 2002, and the filing date of PCT Application No. PCT/AU98/00298.

### BACKGROUND

1. Field

The present application relates generally to the separation of pollutants from water and, particularly, but not exclusively, to a system and process for separating lighter than water liquids such as oil from water for use in inground and aboveground installations where it is desired to prevent oil in water at concentrations above a predetermined limit from being distributed to the environment in an uncontrolled fashion.

2. Description of the Related Art

Mechanical oil from water separator systems are known. Devices/systems are also known that provide settling in chambers separated by baffles—refer the arrangement of FIG. 1 which shows a Prior Art American Petroleum Institute (API) oil from water separator design. It consists of a rectangular tank with two or more vertical partitions or baffles to separate entry chamber, oil disengagement chamber and effluent water chamber, and which is designed to run full of water.

The API oil from water separator is sized to provide low turbulence conditions and sufficient residence time for oil globules with a minimum diameter of 0.015 cm (150 microns) to separate from the oil/water mixture flowing though the separator.

This prior art system can be characterised as a decant-type system where for every input of liquid there is an output of a similar amount at the same time, thereby affecting separation efficiency.

Attempts have been made in the prior art to control the level of the oil/water interface, for example see U.S. Pat. No. 5,147,534 (Rymal) and U.S. Pat. No. 4,031,007 (Sierra) and, more generally, see IJS4960513 (Young), U54436630 (Anderson) and U55378353 (Koch)

In all of these systems, whilst there has been a move away from a simple decant-type approach, there is usually added a specific oil from water separation process beyond mere gravitational separation. Koch requires a specific separate coalescer unit whilst U.S. Pat. No. 4,554,074 (Broughton) utilises separation plates.

The applicants of the present application have developed an oil from water separator that effectively increases the retention time of an oil/water mixture within a separation space to allow more time for separation and therefore reduce the amount of oil remaining in the effluent liquid. The oil/water separator is disclosed in applicant's Australian Patent No. 753227 filed 24 Apr. 1998. The disclosure of this document is incorporated herein by reference.

The oil/water separator of Australian Patent No. 753227 employs a flow retarding device, such as a siphon, to periodically flush a water/oil storage volume and thereby increase the retention of the volume of oil/water mixture for a relatively long period of time compared to the prior art decant type separator devices (such as the API).

Oil/water separator devices such as the API and the device disclosed in Australian Patent No. 753227 are generally employed in “stand-alone” applications for specific sites where oil pollution may be a problem. Examples include petrol stations, and sites housing electrical transformers. There is a major problem with pollution of lighter than water liquids, however, in general catchment areas that may not be associated with isolated sites. These include stormwater systems, drainage systems which may be associated with highways (which may have stormwater drainage), and large area sites such as airports and sea ports, which may have their own drainage systems. Lack of management of pollution here is a significant problem. An oil tanker spillage on a major highway, for example, can cause significant problems for the surrounding environment. Present solutions are inadequate, particularly in the cases where the government implements strict legislation. For example, the New South Wales state government requires, at least for main roads, for a particular length of road to have a drainage system that can cope with two major oil tanker spills (eg in the order of 60,000 liters of oil). One solution that has been employed is the use of detention basins to hold back contaminated waters. These usually involve large surface areas, however, and require some manual intervention. They are impractical for linear roadways in particular, and also areas that aren't flat.

### SUMMARY

In accordance with a first aspect, the present invention provides a light liquid/water separator system, including a light liquid disengagement chamber arranged to retain light liquid containing water in an undisturbed state for a sufficiently long time to achieve a desired degree of separation of the light liquid from the water, the light-liquid disengagement chamber comprising a first stage and a second stage, the first stage including a reticulation structure in liquid communication with a second stage comprising a disengagement chamber within a separator structure.

Preferably, the system includes a flow retarding means for controlling outflow from the separator system in order to preserve said undisturbed state for the sufficiently long period of time.

Preferably, the separator system includes an effluent water chamber which is separated from the light-liquid disengagement chamber partially by an underflow baffle which ducts a light liquid free volume of water to the effluent water chamber, wherein an outflow of a light liquid free volume of water from the effluent water chamber is limited by the flow retarding means to a rate of outflow which is a function of the head of the liquid in the effluent water chamber.

The “light liquid” may include any liquid which is lighter than water (and non miscible) and may include oil. Preferably, the separator system may also be used to contain a water/miscible-liquid mixture by incorporating a means for preventing outflow of the miscible-liquid/water mixture until it has been dealt with.

Preferably, the reticulation structure comprises a drainage system, which may include the storm water drain or storm water piping system. it may include any piping systems for the purposes of drainage or spill control. Preferably the reticulation structure comprises a stormwater drain or stormwater piping system.

Preferably the disengagement chamber in the separator structure is formed between the walls of a first pipe and a second pipe, the second pipe lying within the first pipe.

Preferably the separator structure further includes a third pipe lying within the second pipe and in liquid communication with an outlet from the separator structure, the walls of the second and third pipe forming the effluent water chamber.

Preferably, the pipes are standard pipes of standard sizes as used in standard reticulation arrangements.

Preferably, the separator system is arranged to separate oil from water, and may separate oil from water to such an extent to allow an effluent water outflow containing less than 50 ppm and preferably less than 10 ppm of oil.

In this aspect of the invention, therefore, a reticulation structure, such as a stormwater drain or stormwater piping system, may form part of a separator system. A volume of the reticulation structure may therefore be used to facilitate light-liquid/water separation. The volume of stormwater drains or stormwater piping available, therefore, can be used to advantage to facilitate separation of light-liquid pollutants from the environment served by drainage systems, such as stormwater drainage systems for roads.

Preferably, the separator structure is in accordance with the applicant's earlier Australian Patent No. 753227, incorporating a flow retarding means, and can be utilised together with the reticulation system. This brings together the advantages of utilising the reticulation system itself as part of a light-liquid/water separator, and the advantages of the relatively long retention time in the disengagement chamber of applicant's earlier developed separator arrangement.

Yet a further advantage is that in a preferred embodiment, reticulation elements, such as standard piping, can be used to provide the separator structure. This has the advantage of economy and convenience.

In accordance with a second aspect, the present invention provides a method of calculation of active lag capacity or accumulation capacity for a separator system, the separator system including a reticulation system feeding light liquid containing water into a separator structure, the method comprising calculating active lag capacity or accumulation capacity for the system by including the capacity of the reticulation system in the calculation of the active lag capacity or accumulation capacity for the system.

In accordance with a third aspect, the present invention provides a separator structure for facilitating separation of light liquid from water in a light-liquid/water mixture, the separator structure being comprised of one or more standard pipes defining a light-liquid/water disengagement chamber for retaining the mixture in a sufficiently undisturbed state for a sufficiently long time to achieve a desired degree of separation of the light liquid from the water.

Preferably, the separator structure comprises a first standard pipe of smaller diameter within a second standard pipe of larger diameter, which, in turn, is placed within a third pipe of larger diameter to define the disengagement chamber between the walls of the second pipe or the third pipe, and to define an effluent water chamber between the walls of the first pipe and the second pipe.

Preferably, a flow retarding means is arranged to control outflow from the separator structure to preserve the undisturbed state for the sufficiently long time.

In accordance with a fourth aspect, the present invention provides a method of avoiding outflow of light liquid pollutant into the environment from a drainage system by the steps of incorporating within the drainage system light liquid/water separator structures, the separator structure including a light-liquid/water disengagement chamber which is separated by a baffle from a entry chamber.

Preferably, the separator structure also includes a further baffle separating the light-liquid/water disengagement chamber from an effluent water chamber.

Preferably, the separator structure also comprises a flow retarding means to preserve a light liquid/water mixture in the light liquid/water disengagement chamber for a sufficiently long time to achieve a desired degree of separation of the light liquid from the water.

In accordance with a fifth aspect, there is provided an oil from water separator comprising a disengagement chamber arranged to receive an oil and water mixture and retain it for a sufficient time in a relatively undisturbed state whereby oil in the mixture floats to the top of the mixture resulting in a substantially oil free volume of water having a layer of oil derived from said oil and water mixture floating on the surface thereof; said oil disengagement chamber partially separated from an effluent water chamber by an under flow baffle which ducts said substantially oil free volume of water to said effluent water chamber; said oil from water separator characterised in that outflow of said substantially oil free volume of water from said effluent water chamber is limited by flow retarding means to a rate of outflow which is a function of the head of the liquid in said effluent water chamber.

In accordance with a sixth aspect of the invention there is provided an oil from water separator including an oil disengagement chamber arranged to receive an oil and water mixture and retain it for an extended time in a relatively undisturbed state whereby oil in the mixture floats to the top of the mixture resulting in a substantially oil free volume of water having a layer of oil derived from said oil and water mixture floating on the surface thereof; characterised in that outflow from said chamber is controlled in a predetermined way by flow retarding means.

In accordance with a seventh aspect of the invention there is provided an oil from water separation system including an oil disengagement chamber having a flush storage volume defined between a chamber high liquid level and a chamber low liquid level; a liquid volume equivalent to said flush storage volume caused to exit from said chamber on attainment of said chamber high liquid level.

Preferably said flush storage volume is caused to exit by means of a siphon mechanism.

In accordance with an eighth aspect of the invention there is provided an oil from water separator including an oil disengagement chamber arranged to receive an oil/water mixture and retain it for a sufficient time in a relatively undisturbed state whereby oil in the mixture floats to the top of the mixture resulting in a substantially oil free volume of water having a layer of oil derived from said oil and water mixture floating on the surface thereof; characterised in that outflow from said chamber is prevented until said mixture reaches a predetermined chamber high liquid level whereupon said volume of water is caused to exit said chamber.

In accordance with a ninth aspect of the invention there is provided an oil from water separator including an oil disengagement chamber adapted to receive an oil/water mixture and retain it for a sufficient time in a relatively undisturbed state whereby oil in the mixture floats to the top of the mixture resulting in a substantially oil free volume of water having a layer of oil derived from said oil and water mixture floating on the surface thereof; characterised in that outflow from said chamber is limited by flow retarding means to a predetermined function of the level of said oil and water mixture in said chamber.

Preferably said flow retarding means is operable only between a chamber low liquid level and a chamber high liquid level.

In one particular preferred form said flow retarding means comprises at least one siphon which primes at said chamber high liquid level and loses prime at said chamber low liquid level.

In an alternative preferred form said flow retarding means comprises at least one bleed aperture or weep hole.

Preferably said at least one bleed aperture or weep hole is located at the level of said chamber low liquid level.

More preferably said at least one bleed aperture or weep hole is sized with reference to expected inflow of said oil and water mixture into said oil disengagement chamber such that, during operation, the level of said oil and water mixture will rise from said chamber low liquid level up to a higher liquid level and then return to said chamber low liquid level, thereby defining for each situation an oil and water mixture active lag capacity or accumulation capacity between said chamber low liquid level and said higher liquid level.

More preferably said active lag capacity or accumulation capacity has a characteristic which is a function of
(a) inflow rate
(b) desired residence time of said oil and water mixture in said oil disengagement chamber.

Preferably an oil and water accumulation volume is defined comprising a collection volume external to said separator in liquid communication with said oil disengagement chamber within said separator.

Preferably said separator structure comprises a first standard pipe of smaller diameter within a second standard pipe of larger diameter which, in turn, is placed within a third pipe of larger diameter thereby to define an oil disengagement chamber substantially between the walls of said second pipe and said third pipe and to define an effluent water chamber between the walls of said first pipe and said second pipe.

In accordance with a tenth aspect of the invention there is provided a separator system adapted to accumulate oil-containing water in a sufficiently undisturbed state for a sufficiently long time to achieve a desired degree of separation of oil from water; outflow from said separator controlled to preserve said undisturbed state by flow retarding means.

Preferably said separator includes an oil disengagement chamber in communication with an effluent water chamber.

Preferably said oil disengagement chamber comprises a first stage and a second stage; said first stage comprising a reticulation structure in liquid communication with a second stage comprising a disengagement chamber within a separator structure.

Preferably, the reticulation structure comprises a piping system or drainage system and may include a storm water drain or a storm water piping system, or a piping system arranged to deal with a spill.

Preferably said stage of said oil disengagement chamber within said separator structure is formed between the walls of a first pipe and a second pipe; said second pipe lying within said first pipe.

Preferably said separator structure further includes a third pipe lying within said second pipe and in liquid communication with an outlet from said separator structure; the walls of said second pipe and said third pipe forming said effluent water chamber.

Preferably said second pipe and said third pipe are oriented within said first pipe such that wall portions of said second pipe and said third pipe are arranged to be substantially adjacent a wall portion of said first pipe.

Preferably said wall portions are secured one to the other by an outflow pipe passing substantially therethrough; said outflow pipe in liquid communication with the interior of said third pipe.

Preferably said flow retarding means comprises a siphon operating between said effluent water chamber and said outlet.

Preferably said flow retarding means comprises apertures placed in wall portions of said effluent water chamber and in liquid communication with said outflow pipe.

### BRIEF DESCRIPTION OF THE DRAWINGS

Embodiments of the invention will now be described with reference to the accompanying drawings wherein:

FIG. 1 illustrates a Prior Art (API) separator and

FIG. 2 illustrates a separator system according to a first embodiment of the invention of Australian Patent No. 753227.

FIG. 3 illustrates the sequence of filling and emptying of the separator system of FIG. 2.

FIG. 4A is a graph of head versus flow for the separator system of FIG. 2,

FIG. 4B illustrates in cross section the system of FIG. 2 to which FIG. 4A is applicable.

FIG. 5A is a graph of head versus flow for the system, of FIG. 5B,

FIG. 5B illustrates in cross section a separator system according to a second embodiment of the invention of Australian Patent No. 753227,

FIG. 6A is a graph of head versus flow for the system of FIG. 6B,

FIG. 6B illustrates, in cross section, a separator system according to a third embodiment of the invention of Australian Patent No. 753227 involving multiple weep holes,

FIG. 7 is a graph of the behavior of water level in the system of FIG. 2 in the form of a graph of water level versus time,

FIG. 8 illustrates the behavior of the system of FIG. 2 under alternative operating conditions in the form of a graph of water level versus time,

FIG. 9 illustrates the behavior of the system of FIG. 5 in the form of a graph of water level versus time,

FIG. 10 illustrates particular flow characteristics of particular implementations of the invention of Australian Patent No. 753227 (example 2),

FIG. 11 is a top view and side section view of a separator system according to a further embodiment of the invention of Australian Patent No. 753227,

FIG. 12 is a side section view of multiple separator systems connected in a flow-through, series configuration,

FIG. 13 is a series of section views of an embodiment of a separator system in accordance with an embodiment of the present invention combining concepts from the system of both FIG. 11 and FIG. 12,

FIG. 14 is a side view of a separator arrangement in accordance with a further embodiment of the present invention,

FIG. 15 is a view from direction A on line 4 of FIG. 14,

FIG. 16 is a cross section view from the direction A on line 3,

FIG. 17 is a cross section view from direction A on line 2,

FIG. 18 is a cross section view from direction A on line 1, and

FIG. 19 is a longitudinal section through the embodiment of FIG. 14.

### DETAILED DESCRIPTION OF PREFERRED EMBODIMENTS

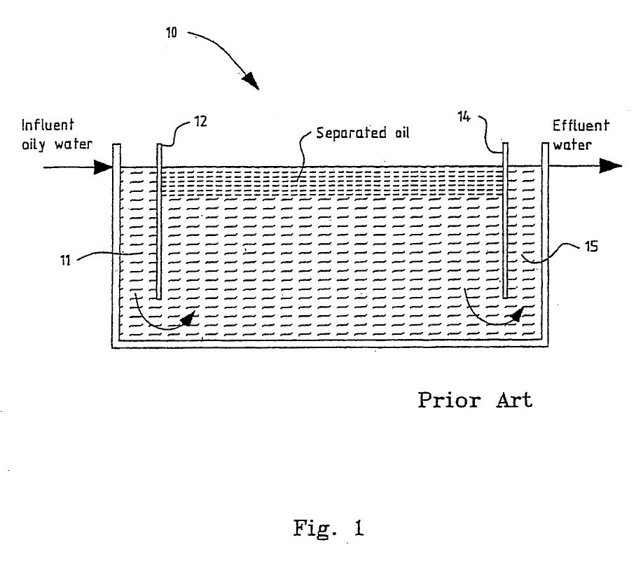

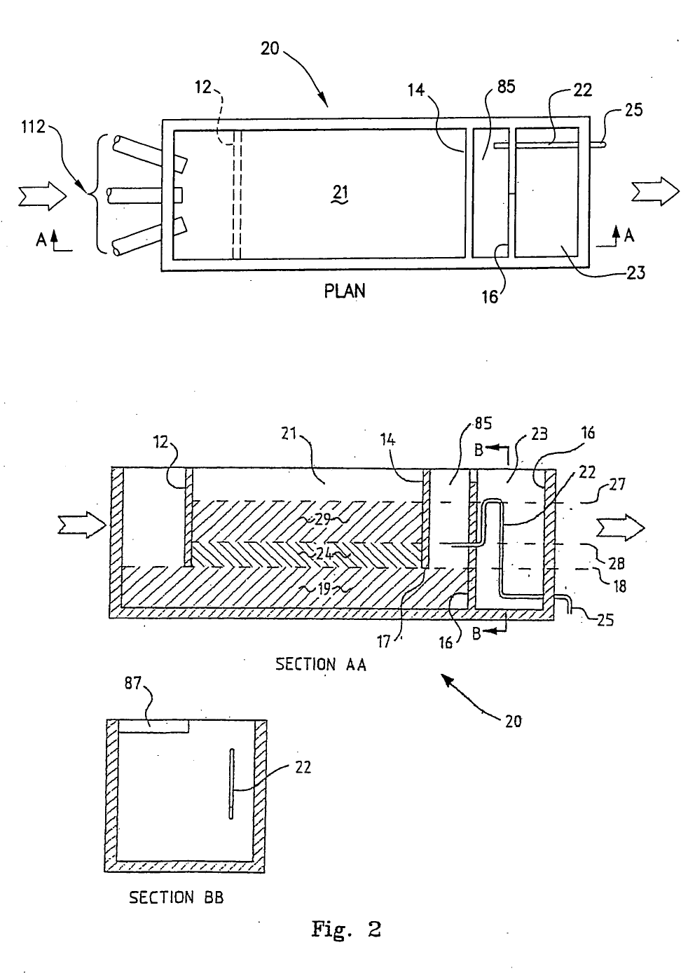

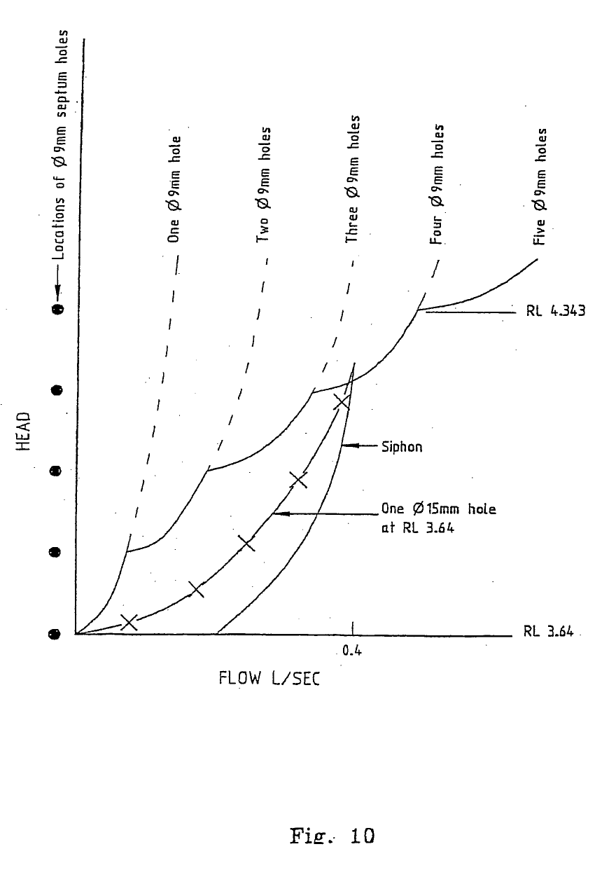

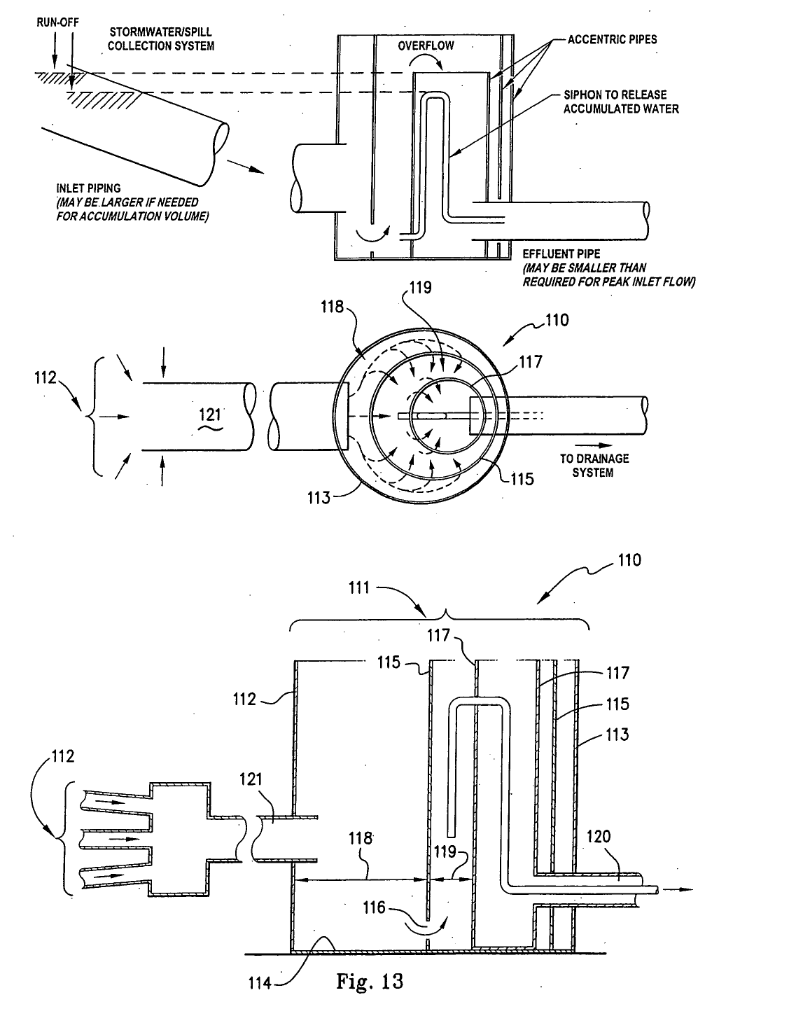

The Prior Art separator 10 of FIG. 1 comprises an entry chamber 11 separated by a baffle 12 from an oil disengagement chamber 13 which, in turn, is separated from an effluent water chamber (15) by a baffle (14). Various embodiments of the separator of Australian Patent No. 753227 will now be described, in relation to FIGS. 2 through 12 of the drawings. Description of these various embodiments will assist in understanding of the separator system and method of the present invention, specific embodiments of which are to be described later with reference to FIGS. 13 through 19 of the accompanying drawings.

The description is given particularly in relation to separation of oil from water, but it will be appreciated that generally any liquid that is lighter than and not miscible with water can be separated from water using the arrangement.

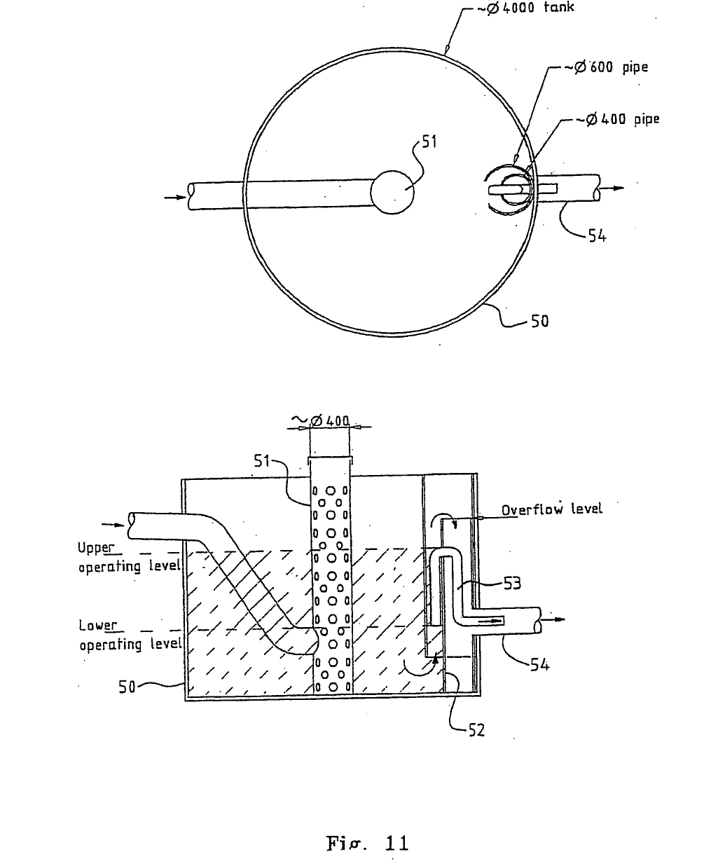

Various embodiments of the invention of Australian Patent No. 753227 as to be described below are characterised in their most broad form by the addition of a flow retarding device to an outlet portion of a separator. The separator can be in the box form of the prior art API separator of FIG. 1 or can take an alternative form (for example refer the cylinder form of example 3 of FIG. 11 to be described later in this specification)

The flow retarding device acts to ensure that for the majority of operating conditions likely to be encountered, water in the storage volume will have a sufficient residence time and flow in a sufficiently undisturbed manner to ensure oil from water separation substantially to a predetermined value eg to comply with environmental regulations.

In the embodiments described below, the flow retarding device operates to retard flow, either in a periodic flow (the flow will sometimes flow) or a continuous flow. The embodiment is different how the outflow is permitted.

In all cases, accumulation occurs in the oil disengagement chamber as a result of control of outflow. Furthermore, it imposes an outflow rate from the separator which is a function of the liquid head over the outflow level in the separator.

First Embodiment

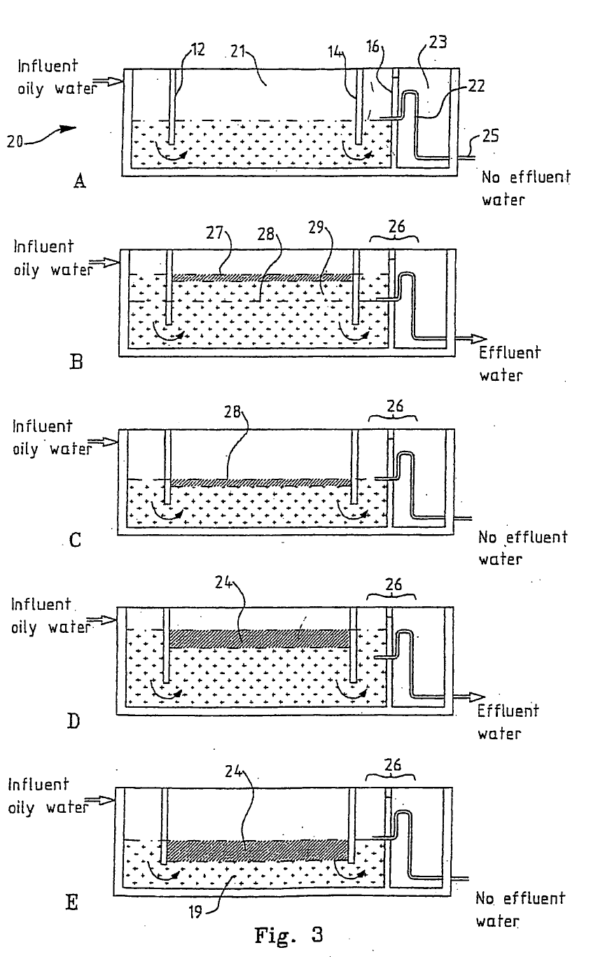

With reference to FIG. 2 an oil from water separator system 20 according to a first embodiment is illustrated. FIG. 3 shows a series of operating conditions A-E for the separator of FIG. 2.

The system 20 directs an influent of oily water through or under a baffle 12 to an oil disengagement chamber 21 the water from which passes beneath a skimmer wall or second baffle 14 to a siphon pipe 22 in an end wall 16. This siphon pipe discharges effluent water into exit pipe 25 through draw off chamber 23. Note that draw-off chamber 23 is not essential to operation.

The siphon pipe 22, in operation, causes the level of liquid in oil disengagement chamber 21 to move between high level 27 and low level 28.

The volume of liquid defined between these two levels forms an accumulation capacity which is designated the flush storage volume or oil and water accumulation volume 29.

In use water laden with oil enters oil disengagement chamber 21 as in FIG. 3 with the level in the chamber 21 rising until the maximum accumulation volume 29 is achieved at which time siphon pipe 22 operates to cause the flush storage volume or accumulation volume 29 to exit via exit pipe 25 until the siphon breaks at low level 28. Low level 28 is selected to be, for design conditions, such that accumulated, separated oil cannot pass under the baffle 14 and escape from the separator oil disengagement chamber.

As more oil laden water enters oil disengagement chamber 21 the process repeats itself in accordance with FIG. 3 C, D.

In this manner a relatively large volume of oil/water mixture is retained for a relatively long period of time to allow oil separation to occur prior to siphoned exit.

Restated in other terms: A feature of this embodiment is the incorporation of one or more automatic siphons which release water only periodically from an oil disengagement chamber and which chamber creates a potential storage for a selected volume of first flush oil/water mixture or a major oil spillage of a volume equal to the flush storage volume or accumulation volume 29.

This volume 29 is sized to contain a major oil spillage or to be filled progressively with oil/water mixture from successive rainfall events. Until this volume 29 is accumulated, oil globules can coalesce and separate from the water over a period greater than the residence time available in the standard flow through decant separator of FIG. 1 for a given separator tank volume. The oil disengagement chamber 21 is quiescent with virtually zero turbulence except at the end of each cycle when the siphon is operating.

When the water surface reaches a selected chamber high liquid level 27 a siphon which discharges into draw off chamber 23 is primed whereby substantially oil-free water is released until the water surface falls to a selected chamber low liquid level 28 at which the siphon breaks. This releases a volume of effluent water equal to the accumulation volume 29 leaving capacity for the next cycle of oil/water inflows.

One can more specifically differentiate the volumes of liquid in the separator and, more specifically in the oil disengagement chamber as follows:

A. The flush storage volume or oil and water accumulation volume 29 as previously defined comprising that volume of liquid which can be accumulated in the disengagement chamber 21 between low level 28 and high level 27.

A volume 24 defined as the volume of liquid which can be stored in the chamber 21 between low level 28 and the lower edge 17 of baffle 14 defined at under pass level 18 in FIG. 2. A volume of oil equal to this volume can be accumulated in the separator without oil entering the effluent chamber 85.

A quiescent zone consisting of volumes 19, 24 and 29 downstream of inlet baffle 12. Volume 19 is defined between underpass level 18 and the bottom of the disengagement chamber 21.

As will be appreciated the volume 19 will, in use, always contain a liquid. In a correctly sized and designed separator this liquid will be substantially effluent water.

As will be further appreciated periodic flushing of the separator by operation of the flow retarding device 26 will result in a volume of liquid equal to the oil and water accumulation volume 29 being moved from the oil disengagement chamber 21 through the effluent water chamber 85 and, via the flow retarding device 26 to the draw off chamber 23 and exit pipe 25. The liquid actually moved will include liquid found in all of the defined volumes 19, 24, 29, but not all of it in any one instance.

It is the oil and water accumulation volume 29 with its dynamic nature in that separation can take place within this volume whilst the liquid actually contained within the volume changes in quantity over time which provides the substantive separation characteristic and permits effective residence times of the order of hours (thereby achieving effective oil/water separation) for a treatment capacity in a given separator size greater than can be achieved with an equivalent sized API-type separator.

It will be further observed that when outflow does occur the rate of outflow is a function of the head of the liquid in the effluent water chamber 85.

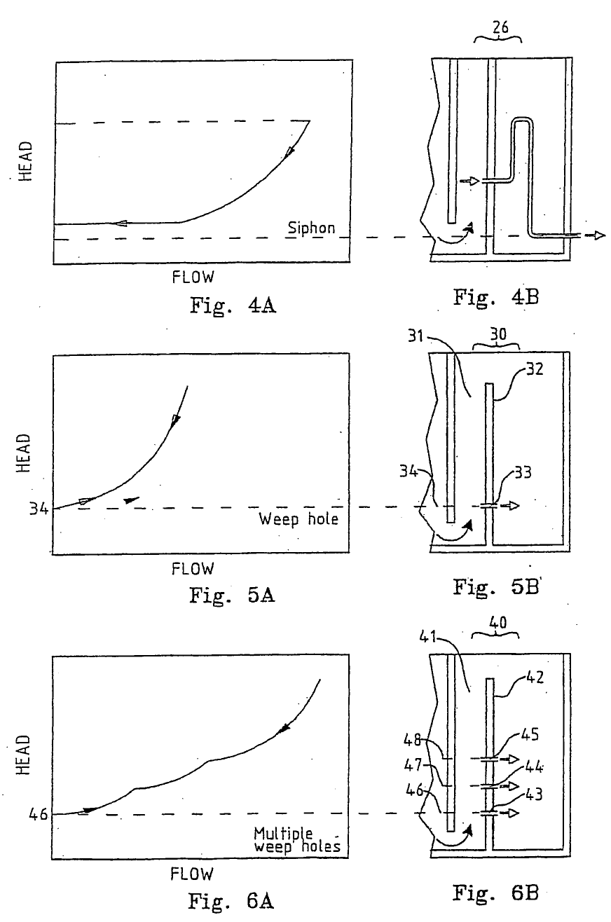

FIG. 4A illustrates a head versus flow characteristic for the siphon arrangement of the first embodiment of FIG. 2.

FIG. 4B is a side section view of the siphon-based retarding device 26 of FIG. 2.

Second Embodiment

FIG. 5B illustrates a second embodiment of the invention of Australian Patent No. 753227 (in cross section) comprising a flow retarding device 30 in the end wall of a storage volume 31. In this instance the flow retarding device 30 comprises a retention wall 32 having a bleed aperture 33 (also termed a weep hole) therewith which will permit the gradual release of liquid in storage volume 31 above a predetermined low level 34. The head versus flow characteristics for this arrangement are shown in FIG. 5B.

Third Embodiment

An alternative arrangement of the system of the invention of Australian Patent No. 753227 according to a third embodiment is illustrated in cross section in FIG. 6B and comprises, in this instance, a retention wall 42 in an end wall of storage volume 41 having within it a first bleed aperture 43, a second bleed aperture 44 and a third bleed aperture 45 located at respective predetermined levels 46, 47, 48.

FIG. 6A shows a graph of head versus flow for this multiple weep hole embodiment of the flow retarding device 40.

Broadly it will be observed that the first embodiment of FIG. 2 utilises a siphon to achieve controlled flow retardation whilst the second and third embodiments utilise weep holes.

Whereas water will not start to flow through a siphon until a priming level is reached and will continue to flow until the water surface reaches some lower level, water will flow through a hole whenever the hole is submerged on and only on the upstream side.

The objective of controlling the release of water from an oil from water separator is to provide residence time in the separator during which the desired separation of oil droplets from the water can occur.

The siphon achieves this residence time by storing incoming water until the provided capacity is full, when the relatively oil-free water is released and the cycle starts again.

In some applications of a disengagement chamber for oil from water separation, the load may be regular as in daily washdowns and in these applications a slow drawdown overnight may be more desirable than the siphon characteristic.

Such an alternative characteristic can be achieved by replacing the siphon with weep holes, varying their number, sizes and locations to achieve any desired outflow/level relationship. This allows the water surface in the separator to return slowly to the bottom operating level without first reaching some top operating level but after a sufficient time for oil from water separation.

The relationship between separator water level and outflow for a siphon and one or more weep holes is illustrated in FIGS. 4A, 5A and 6A as earlier described.

Relative Inflow-Outflow Behavior

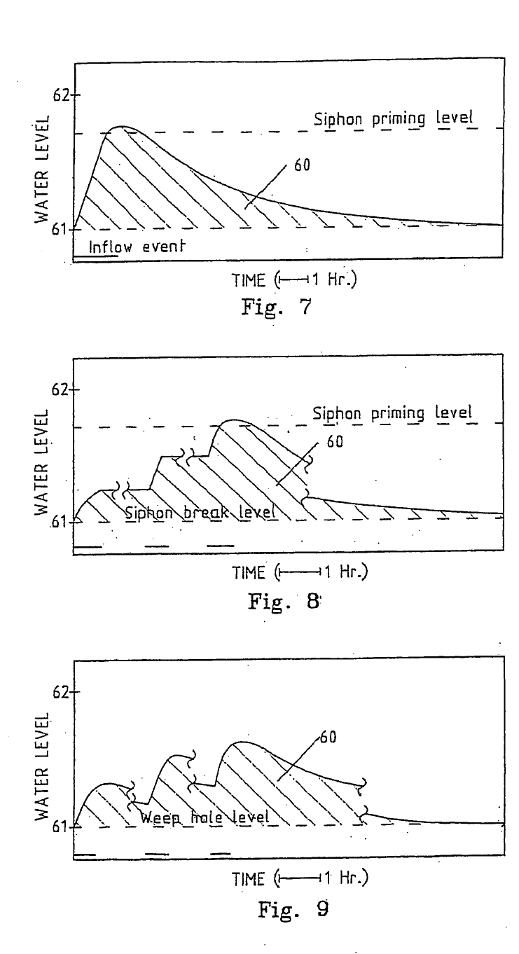

The movement in separator water level during an inflow event, however, will be broadly similar for the siphon and the weep holes, at least as far as achieved residence time is concerned. With some generality it can be asserted that:
An effective separator design will not require a cycle time (from rising above the bottom operating level to returning to it) of more than 12-24 hours
For rainfall runoff typical of a 1 in 1 year event, the separator can fill to the top operating level in less than an hour
The initial rise of the separator water level will be steep compared with the exponential fall after the outflow through the weep holes or the siphon (see FIGS. 7, 8 and 9)
The earlier release of water through a weep hole than will occur with a siphon not yet at its priming level will have negligible effect on the initial rise in water level
During water level fall from the top operating level, the flow through both the weep hole and the siphon will decline exponentially as a function of head above the outlet
If the inflow event is not large enough to prime the siphon, the water will remain in the separator until there is sufficient water; with a weep hole, the water outflow will continue to decline exponentially until the weep hole level is reached, still providing (by design) the desired residence time.
   Fourth Embodiment

FIG. 11 illustrates an alternative storage volume arrangement which, as seen in plan view, takes the form of a doughnut-shaped tank 50 with inflow to a central distributor in the form of a stand pipe 51. Outflow is from a circular retention wall 52. Controlled outflow is achieved either via a siphon pipe 53 to clarified water outlet 54 or via bleed apertures (not shown) in retention wall 52 or other flow retarding means. For this embodiment dimensions of the siphon pipe and/or the bleed apertures can be as for either example 1 or example 2 below.

Active Lag Capacity

With reference to FIGS. 7, 8 and 9 the previously described embodiments can be seen to incorporate an active lag capacity or accumulation volume 60 which operates above a predefined liquid low level 61 and can extend as high as a predefined liquid high level 62 set by an overflow weir (such as weir 87 in FIG. 2).

The active lag capacity 60 comes into operation when inflow to the oil disengagement chamber is such that the liquid level rises above liquid low level 61.

Liquid low level 61 has associated with it, in these examples, either the lower end of a siphon or the lowest of at least one weep hole sized in the manner previously described and which, in combination with the end wall 16 or retention walls 32, 42, 52, forms a flow retarding means which is the dominant factor which controls the shape and characteristic of the active lag capacity 60 for a given inflow characteristic and storage volume characteristic.

The active lag capacity 60 by virtue of its coming into existence whilst there is mismatched relative inflow and outflow from the oil disengagement chamber has a dynamic or active characteristic which assists in efficient oil from water separation such that, for a predefined range of inflows, outflow will contain a proportion of oil in water substantially below a predefined limit.

Fifth Embodiment—Interconnected Separator Units

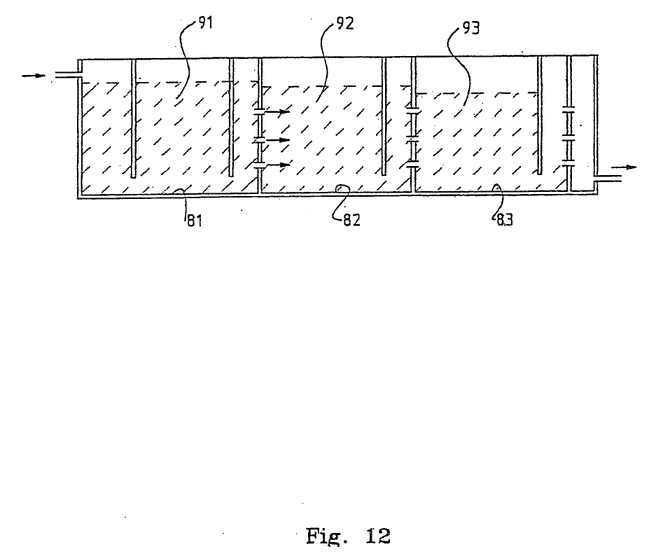

With reference to FIG. 12 three separator units are connected in series whereby a first separator 81 having a lag capacity in the form of a first active lag volume 91 feeds its output, as illustrated, directly into second separator unit 82 having a second active lag volume 92, which separator unit in turn feeds its outflow into third separator unit 83 having a third active volume 93. In this instance the active lag capacity of the total system is determined by the composite characteristic of the active lag volumes 91, 92, 93.

This arrangement has particular advantage where site shape and/or size dictates that one large tank is inappropriate. The arrangement also provides additional flexibility in terms of total residence time.

It has one particular distinguishing characteristic as compared with the single tank implementations in that overflow from first separator 81 in the event of unforeseen catastrophic inflow merely results in overflow of untreated or insufficiently treated oil/water mix into second volume 92 of second separator 82 rather than the immediate discharge of untreated or insufficiently treated oil/water mixture from the entire treatment system. This multiple tank arrangement, therefore, provides a “soft-fail” mode as well as providing additional design flexibility.

Examples of the various embodiments will now be given:

### EXAMPLE 1

An API type rectangular tank with siphon installed in the exit wall. Typical dimensions are 7 m long, 1.5 m wide and siphon operating levels 1.6 m and 0.8 m above the floor. Volume=approx 17 KL, about half of which is the range between siphon operating levels. The siphon is made of 18 mm OD hard drawn copper pipe and takes about 10 hours to draw the water level down.

### EXAMPLE 2

FIG. 10 illustrates a particular example of head versus flow behavior for the siphon embodiment of FIG. 2, the single weep hole embodiment of FIG. 5 and the multiple weep hole embodiment of FIG. 6 for various hole diameters as indicated.

Embodiments of the present invention, which in some embodiments incorporate a volume of reticulation (eg, drainage, piping, etc) as part of the separator system, and may also include a separator structure made from standard reticulation pipes, will now be described with reference to FIGS. 13 through 19.

With reference to FIG. 13 there are illustrated section views of a separator system 110 which has particular application, but not exclusively, for stormwater management and spill control.

It will be noted that, broadly, the separator of previous embodiments has been designed to accumulate oil-containing water in a sufficiently undisturbed state for a sufficiently long time to achieve the desired separation of oil from the water. The outflow of water thereafter is controlled to preserve the undisturbed state by a flow retarding means such as a siphon.

This concept of accumulation and controlled slow release has now been extended by the present invention to the management of bulk, distributed flows derived from geographically distributed sources such as stormwater, which can carry oil from oily surfaces such as roadways as well as bulk spills of oily liquids. The prior art practice of piping stormwater flows without delay to major drainage systems delivers the carried oil to these systems, often with undesired environmental impacts. Release of bulk oil spills is now not acceptable.

Detention basins have been employed to hold contaminated waters back but usually involve large surface areas and some manual intervention. They are impractical for example for collection from linear roadways.

The oil separator system 110 of FIG. 13 now described addresses these problems in the following novel ways:

It uses the potential storage volume in the existing stormwater collection system to hold back at least the major portion, including the first flush, of the water collected from a specified catchment surface during a drainage event, such as a rain event or a spill event.

It reduces substantially the maximum flow in the stormwater piping downstream of the separator, even in the situation of a rain or spill event greater than that for which the system is designed, and reduces erosion and flooding in downstream drainage systems

It captures any spilled liquid in the separator collection system, including washdown water, for managed recovery

In one version of the extension concept the separator structure 111 is constructed from standard steel reinforced concrete drainage pipes and fittings using standard pipelaying practice. This is convenient and economical.

With reference to FIG. 13 an effective arrangement has been designed for capturing a certain spilled volume of any liquid lighter than and non-miscible with water while allowing the through-flow of additional water and admixed water which separates during the capture and detention period. It can also capture and hold a quantity of any liquid up to the installed capture volume if there is no other water inflow at the time.

Layouts will be site-specific, but in the general case will consist of collection piping 112, with a minimum volume equal to the desired capture volume, connected into the side of a 2.44 m section of large first standard pipe 113 standing vertically on a standard base 114. Inside this first standard pipe 113 stands a smaller second standard pipe 115 with portal openings 116 at the floor end, of area sufficient for a specified peak through-flow.

Inside this second standard pipe 115 stands a third, smaller standard pipe 117 with effective sealing at its base (which may require it to have its own standard base resting on the base of the first, standard pipe 113). The three pipes 113, 115, 117 will be located such that the water velocity in the first annulus cross section 118 and second annulus cross section 119 does not exceed desired maximum values. The two inner pipes 115, 117 can be secured in position and strengthened by cutting in the effluent pipe 120 through the outer and two inner pipe walls, as is normally done with single walls. In a particular preferred form the three pipes 113, 115, 117 will have minimum separation on the opposite side to the entry pipe 121.

As with previous embodiments the components of separator system 110 are sized to ensure that accumulating water does not stay in the separator structure 111 longer than is needed for adequate oil separation (about six hours). Even if a tanker spill were to occur before preceding stormwater had emptied out, a non-miscible lighter-than-water oil would still be fully contained in the separator structure 111 with only the displaced clean water flowing to the effluent piping 120. This would occur automatically—it would not be necessary for several hours for operator intervention for isolation and recovery of the spilled material. Operator intervention can be achieved by a pilot siphon with a manual valve accessible from the top of the separator structure.

The concept of utilising existing reticulation to form part of the oil and water accumulation volume comprising collection piping 112 together with the oil discharge chamber formed as first annulus 118 between the walls of first standard pipe 113 and second standard pipe 115 can be applied to earlier described embodiments of the invention of patent no 753227.

With reference to FIG. 2 collection piping 112 may be added, as shown and may be taken to form part of the oil and water accumulation volume of previous embodiments thereby requiring its capacity to be taken into account when determining calculations for residence time of the system.

From one view the collection piping 112 being taken to form part of the oil and water accumulation volume can be considered analogous to the volume of first separator 81 shown in FIG. 12 and forming part of first active storage volume 91 described with respect to the fifth embodiment.

It will be appreciated that the offset center “pipe within a pipe” arrangement maximises open flow passage within the oil disengagement chamber defined between the walls of the first standard pipe 113 and the walls of the second standard pipe 115 thereby minimising turbulence. The offset structure also aids in mechanical support of the three upstanding pipes, thereby minimising the need for additional structural support of the separator structure 111.

An example of implementation of the FIG. 13 embodiment will now be given, with dimensions:
Capture volume required=30 kL
Volume of one 1800 mm standard pipe section (2440 mm long)=6.2 m3
Five (5) lengths of 1800 pipe would provide sufficient capture volume.
(If a level inlet pipe length greater than 12.2 m were available, a smaller pipe size could be used.)

Assume a 2400 mm standard pipe length and pit base are available for the outer containment of the EGOWS unit.

Consider an 1800 mm standard pipe for the second vertical cylindrical wall. The annulus area will be the difference between the inner cross-sectional area of the 2400 pipe (4.53 m2) and the outer cross-sectional area of the 1800 pipe (3.21 m2) ie. 1.32 m2. The average water velocity in the annulus for a peak water flow of 2 m3/s will be 1.52 m/s.

Now consider a 1200 mm standard pipe length and pit base are available for the third (innermost) vertical cylindrical wall. As above, the average water velocity in the annulus for a peak water flow of 2 m3/s is calculated to be 1.82 m/s.

Other flow conditions can be designed if preferred by selecting other standard pipe sizes.

The sizing of stormwater piping systems has to allow for peak runoff flows, which occur for quite short periods, particularly where retention in the catchment is low (eg. on a freeway). It is probable that the inflow will have peaked before the inflow fills the capture volume available in the inlet pipe system for storage and oil separation; then the peak flow downstream of the separator may be considerably lower than the peak flow upstream. This should reduce the erosive effect of peak stormwater flows and could allow smaller downstream pipe size. If this backing up in the inflow pipe system is acceptable (and it reflects current philosophy in dealing with stormwater and its attendant pollution impacts) then a safeguard can be established for any stormwater inflow by designing the downstream piping to act as a flow choke. All that is needed is to have sufficient capture volume available when needed and the provision of capture volume commensurate with the contents of a road tanker would normally achieve this.

A feature of this embodiment can be used to ensure that accumulating water does not stay in the separator longer than is needed for adequate oil separation (about six hours). Even if a tanker spill were to occur before preceding stormwater had emptied out, however, a non-miscible lighter-than-water oil would still be fully contained in the separator with only the displaced clean water flowing to the effluent piping. This would occur automatically—it would not be necessary for several hours for operator intervention for isolation and recovery of the spilled material.

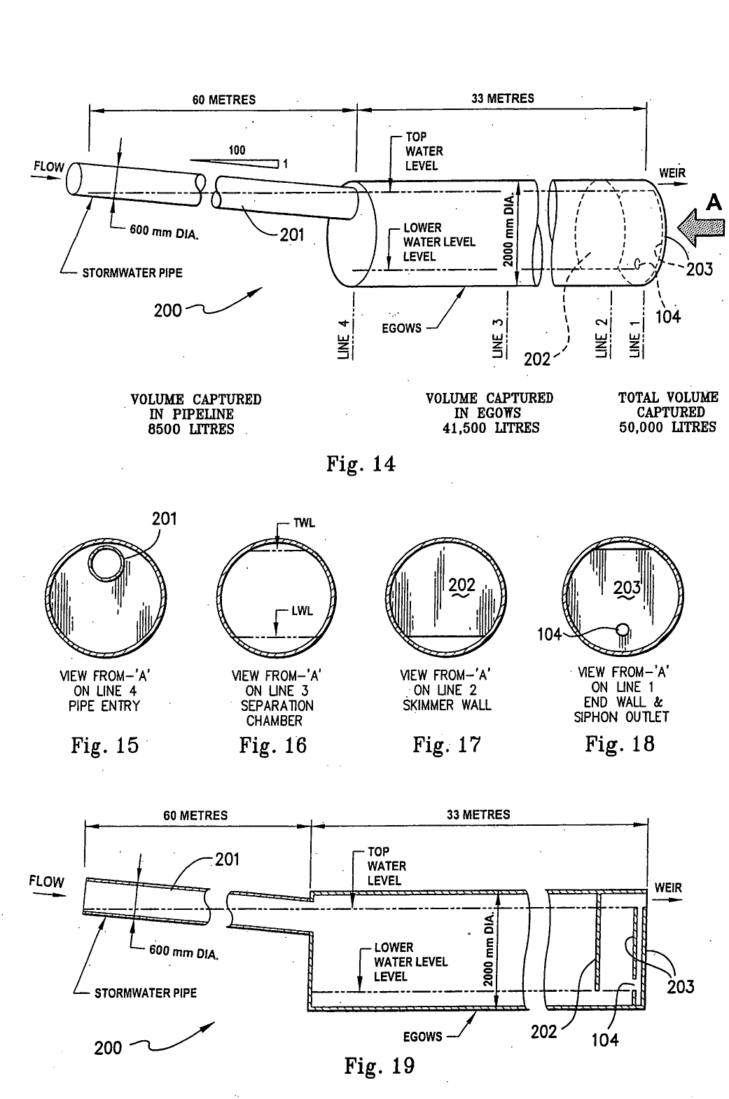

A further embodiment of the present invention will now be described with reference to FIGS. 14 through 19. The embodiment of FIGS. 14 through 19 includes a separator structure 200 of cylindrical form and constructed from standard piping. It is joined with a drainage line 201 from, for example, a stormwater drainage system. As can be seen most clearly in FIG. 19, the separator structure includes a skimmer wall 202 and an end wall 203. A siphon 104 is positioned within the end wall and operates as per preceding described embodiments of the present invention. In this embodiment, the drainage line itself can accommodate 8,500 liters of oil and the separator structure, 41,500 liters, to give a total capture volume of 50,000 liters. In a situation where an accidental spillage becomes noticed within an hour or so of occurring, this would operate to capture the oil, eg. from a tanker accident on a road, and adequate time for the oil to be pumped out without it going into the environment. Additional storage volume can be achieved by lowering the point of entry of the drainage line with respect to the separator structure 200. In the case of the FIG. 14 arrangement, lowering of the point of entry of the draining line by 1 meter would gain an additional 28,000 liters of piping volume for oil storage. This would mean also that the drainage line would be operating as a pressure pipe but the head would be fairly small.

The dimensions shown in this illustration are typical but may vary with different sizes of pipes.

A mixture of water and miscible pollutants may be captured by the device. This depends upon the fact that the pollutant anclarater would proceed in plug flow with little mixing at the interface and just the closure of an isolating valve downstream of the separator would contain it within the separator. An operator may tend a short time after occurrence of the spill to remove the pollutant.

The above describes only some embodiments of the present invention and modifications obvious to those skilled in the art can be made thereto without departing from the scope and spirit of the present invention. It is expected that, in many embodiments, operation of the oil from water separator system can be unattended and/or automatic.

1. A light-liquid/water separator system incorporated into a water reticulation structure, comprising a light liquid disengagement chamber arranged to retain light liquid containing water in an undisturbed state for a sufficiently long time to achieve a desired degree of separation of the light liquid from the water, the light liquid disengagement chamber comprising a first stage and a second stage, the first stage including a reticulation structure in liquid communication with the second stage comprising a disengagement chamber within a separator structure.

2. A separator system in accordance with claim 1, further including a flow retarding means for controlling outflow from the separator system in order to preserve the undisturbed state for the sufficiently long period of time.

3. A separator system in accordance with claim 2, further including an effluent water chamber which is separated from the disengagement chamber partially by an underflow baffle which ducts a substantially light liquid free volume of water to the effluent water chamber, and wherein an outflow of the substantially light liquid free volume of water from the effluent water chamber is limited by the flow retarding means to a rate of outflow which is a function of the head of the liquid in the effluent water chamber.

4. A separator system in accordance with claim 1, wherein said reticulation structure comprises a stormwater drain or stormwater piping system.

5. A separator system in accordance with claim 4, wherein said disengagement chamber within said separator structure is formed between the walls of a first pipe and a second pipe; said second pipe lying within said first pipe.

6. A separator system in accordance with claim 5, wherein said separator structure further includes a third pipe lying within said second pipe and in liquid communication with an outlet from said separator structure; the walls of said second pipe and said third pipe forming said effluent water chamber.

7. A separator system in accordance with claim 6, wherein said second pipe and said third pipe are oriented within said first pipe such that wall portions of said second pipe and said third pipe are arranged to be substantially adjacent a wall portion of said first pipe.

8. A separator system in accordance with claim 7, wherein said wall portions are secured one to the other by an outflow pipe passing substantially therethrough; said outflow pipe in liquid communication with the interior of said third pipe.

9. A separator system in accordance with claim 2, wherein said flow retarding means comprises a siphon operating between said effluent water chamber and said outlet.

10. A separator system in accordance with claim 1, wherein said flow retarding means comprises apertures placed in wall portions of said effluent water chamber and in liquid communication with said outflow pipe.

11. A method of calculation of active lag capacity or accumulation capacity for a separator system, the separator system including a reticulation system feeding light liquid containing water into a separator structure, the method comprising calculating active lag capacity or accumulation capacity for the system by including the capacity of the reticulation system in the calculation of the active lag capacity or accumulation capacity for the system.

12. A separator structure incorporated into a water reticulation structure for facilitating separation of light liquid from a light liquid/water mixture, the separator structure being comprised of one or more standard pipes defining a light liquid/water disengagement chamber arranged to retain the mixture in a sufficiently undisturbed state for a sufficiently long time to achieve a desired degree of separation of the light liquid from the water. The separator structures including a light-liquid/water disengagement chamber which is separated by a baffle from a entry chamber.

13. A method of avoiding outflow of light liquid pollutant into the environment from a drainage system by the steps of incorporating within the drainage system light liquid/water separator structures, the separator structure including a light-liquid/water disengagement chamber which is separated by a baffle from a entry chamber.

14-47. (canceled)

48. A light-liquid/water separator in accordance with claim 1, including a shut off means for shutting off effluent liquid flow, whereby a miscible pollutant may be contained.
